(19) United States
(12) Patent Application Publication
(10) Pub. No.: US 2012/0239981 A1
(43) Pub. Date: Sep. 20, 2012

(54) Method To Detect Firmware / Software Errors For Hardware Monitoring

(75) Inventors: Jeffrey Michael Franke, Apex, NC (US); Tu To Dang, Cary, NC (US); Michael C. Elles, Apex, NC (US); James A. Vignola, Raleigh, NC (US)

(73) Assignee: INTERNATIONAL BUSINESS MACHINES CORPORATION, Armonk, NY (US)

(21) Appl. No.: 13/047,917

(22) Filed: Mar. 15, 2011

(51) Int. Cl. G06F 11/36

(52) U.S. Cl. 714/38.1; 714/E11.217

(57) ABSTRACT

Error reporting software-based method where an error list for a currently-running version of some target software (or firmware) is compared to an error list for a previous versions. Helpful information can be gleaned from the comparison of error lists. For example, if it is known that the hardware configuration has not changed, as between the two lists, and there is an error on the current list that does not appear on the previous list, then this indicates that the error is in the software update and is not a hardware problem.

### BACKGROUND

1. Field of the Invention

The present invention relates to updating of software and/or firmware (herein called “non-hard-ware”) and more particularly to detection and/or identification of errors during updating of non-hard-ware.

2. Description of the Related Art

Methods of updating non-hardware are known. More specifically, it is known that software or firmware or both may be updated, even as the underlying hardware remains constant. These updates may be done for various reasons, such as to increase compatibility with various hardware sets, so improve performance of the non-hard-ware, to add functionality of the non-hardware, to help prevent attacks on the non-hard-ware by malicious code, to fix bugs in the non-hard-ware and so on.

When non-hard-ware is run in its initial version, or is run after an update, it is known to create a list of active problems and to identify each active problem as a suspected hardware problem, a suspected software problem or a suspected firmware problem.

It is known that software or firmware which monitors hardware is sometimes released to customers with coding bugs. This is known to be more common when the non-hardware may be run on a large number of devices, or on a large number of different systems, with each system being a different combination of devices, such as various combinations of computers and peripheral printers, for example. This is because the number of various, possible hardware configurations becomes cost-prohibitive to exhaustively test as the number of possible device permutations increases.

### BRIEF SUMMARY

The present invention recognizes that when updated non-hard-ware is installed in place of an older version of the non-hard-ware, it is possible for the error reporting code to incorrectly report hardware errors that were not reported by the error reporting code when the older version of the non-hard-ware was run—meaning that there is not really an error, or at least that the error is not really a hardware error. The present invention recognizes that in some cases this inaccurate reporting of hardware errors, and/or this incorrect identification of non-hard-ware errors as hardware errors, can lead to costly replacement of hardware which is properly working. The present invention recognizes that this unnecessary replacement increases repair and replacement costs and can eventually cause a loss of customer confidence.

One aspect of the present invention is directed to a system or method that uses more than one list of fault conditions, including at least the following: (i) a first list of fault conditions as detected under the current version of the non-hardware; and (ii) a second list of fault conditions as detected under the previous version of the non-hard-ware. In some embodiments, this use of multiple fault lists will be used in conjunction with the fact that the hardware is constant with respect to both the first and second fault lists in order to identify a detected problem as a non-hard-ware problem rather than as a hardware problem. Accurately identifying the root cause of problem as a non-hard-ware problem, rather than a hardware problem, can save diagnostic effort, repair time and warranty-related costs.

In an aspect of the present invention, when a non-hard-ware update starts, the error reporting code will save (to some sort of persistent memory) a first list of active problems as detected under the previous version of the non-hardware as running on the hardware configuration that is about to be updated with the updated version of the non-hardware. Then the hardware configuration is updated to the updated version of the non-hardware while the hardware configuration is generally maintained as a constant. After the non-hard-ware update, the error reporting code creates a second list of active problems as detected under the updated version of the non-hard-ware. Once the second list is deemed stable, such as after a predefined learning period has passed, and the hardware configuration is known to have remained constant, then the new problems that are on the second list, but not on the first list will be identified by the error reporting code as non-hardware-problems (that is, software problems, firmware problems). At least in some embodiments of the present invention, care should be taken so that latent hardware problems are not misidentified as software problems. More specifically, a latent hardware problem occurs when a new version of the software relies upon hardware resources that the previous version did not rely upon, and it turns out that those particular hardware resources are subject to a hardware problem. For example, this sort of latent hardware problem could be implicated where a reboot or reset accompanies an update. One possible method for countering latent hardware problems is to rerun the previous software version again to see if the problem goes away. In this case, the root cause can be quickly identified by comparing results of two versions of the non-hard-ware (new and old). Under this method it may be helpful for the previous non-hard-ware to have a previous image saved, but neither the saving of this image, nor, more generally any measures to guard against latent hardware errors are required for all embodiments of the present invention.

The problems that are on the second list, but not on the first list, are candidates for software or firmware errors rather than hardware errors, especially if it is known with confidence that the hardware configuration has not changed. As will be discussed below, some embodiments of the present invention may have the capability of detecting hardware changes. Other embodiments of the present invention may assume a stable hardware running environment. According to some, more-complex embodiments of the present invention, a smarter version can associate specific problems to “related hardware components.” If the related hardware did not change then these embodiments can still flag the new problem(s) as software upgrade issues.

In some embodiments, the new firmware can supply a list of new hardware errors that are being monitored. In these embodiments, the new errors can be removed from the list in the comparison as it is expected that the older software/firmware was not capable of producing that error. In these embodiments, one goal is to improve hardware monitoring and take into account that the previous version did not provide that level of monitoring. Thus, some embodiments according to the present invention include software/firmware that can detect new hardware failures so that these are not going to be misinterpreted as coding bugs.

The methods of the present invention may be practiced through various kinds of interfaces. A customer (end-user) interface could be used. Alternatively, access to the methods of the present invention could be limited to service and test organizations. The error reporting code could be run automatically upon a non-hard-ware update, or it may require human intervention to instruct it to run. The results ultimately obtained and refined by the methods of the present invention may be presented in human readable format, or may only be limited to machine readable format (that is, reported only to other parts of the computer system for further automatic processing and/or software based diagnostics). Also, while the methods of the present invention generally require that at least one update has been performed at some point in time, this does not necessarily mean that the generation and/or reporting based upon comparison of the first (previous version) and second (updated version) lists need to be performed close in time to the update itself (although that may be preferable in some embodiments). Further, more than two lists may be compared if multiple updates have been made. For example, a first (initial software version) list, second (current software version), third (first intermediate software version) and fourth (second intermediate software version) could all be compared in order to track and/or better identify errors over time, such as errors that seemed to be fixed in an intermediate software version, but then came back in a current software version.

In some embodiments of the present invention, the error reporting code will maintain images for the active errors list for each and every software version (that is, the initial software installation and all subsequent). In other embodiments, the error reporting code will only maintain an image of an error list until such time as the software version to which it corresponds is updated and the saved image is used as a first list to be compared to the second list corresponding to the updated software. In other embodiments of the present invention, the images of error lists for current and/or previous software versions will only be maintained until a change in the hardware configuration is indicated by the user or automatically detected by the error reporting code.

In some embodiments of the present invention, when a non-hard-ware update is about to be performed, the error reporting code may cause the about-to-be-replaced version of the non-hard-ware run one last time so that the first list can be generated, and later compared to the second list. In these embodiments, the update to software and/or firmware would be made after the about-to-be-replaced non-hard-ware does its last “diagnostic” run and the first list is obtained. This method has the advantage that it is unlikely that the hardware configuration would change between the last “diagnostic” run of the previous non-hard-ware and the initial run of the newly-updated software. The firmware could automatically, or at operator request, perform validation step by rerunning the previous version of software or firmware generating a list for a second time on the old and new software or firmware. An option can be added to keep the user on the old software or firmware and report the new problem to support.

According to an aspect of the present invention, a detection method is controlled at least in part by error reporting software (stored on a software storage device). The method includes the following steps: (i) providing a target non-hard-ware component having version N (ii) (subsequent to step (i)) running the version N target non-hard-ware on a set of target hardware and simultaneously detecting a first result list of active problems, (iii) (during and/or subsequent to step (ii)) saving the first result list, (iv) (subsequent to step (ii)) updating the non-hard-ware to a version N+1, (v) (subsequent to step (iv)) running the version N+1 target non-hard-ware on the set of target hardware and simultaneously detecting a second result list of active problems, (vi) (during and/or subsequent to step (v)) comparing the first result list and the second result list to obtain comparison-based information and (vii) (during and/or subsequent to step (vi)) outputting the comparison-based information.

According to a further aspect of the present invention, error reporting software (stored on a software storage device) is designated to report errors in at least versions N and N+1 of a target non-hard-ware running on a set of target hardware. The software includes: an error detection module, an error list comparison module and an error reporting module. The error detection module is programmed to generate a first result list of errors encountered when version N of the target software is running on the set of target hardware. The second result list of errors is encountered when version N+1 of the target software is running on the set of target hardware. An error list comparison module is programmed to compare the first result list with the second result list to obtain comparison-based information. An error reporting module is programmed to output the comparison-based information.

According to a further aspect of the present invention, a computer system includes a processing hardware set, a software storage device and error reporting software. The processing hardware set is structured, located, connected and/or programmed to run the error reporting software. The software storage device is structured, located, connected and/or programmed to store the error reporting software. The error reporting software is designed to report errors in at least versions N and N+1 of a target non-hard-ware running on a set of target hardware. The error reporting software includes an error detection module programmed to generate: a first result list of errors encountered when version N of the target software is running on the set of target hardware and a second result list of errors encountered when version N+1 of the target software is running on the set of target hardware. An error list comparison module is programmed to compare the first result list with the second result list to obtain comparison-based information. A error reporting module is programmed to output the comparison-based information.

### BRIEF DESCRIPTION OF THE SEVERAL VIEWS OF THE DRAWINGS

The present invention will be more fully understood and appreciated by reading the following Detailed Description in conjunction with the accompanying drawings, in which:

FIG. 1 is a flowchart showing a first embodiment of a method according to the present invention;

FIG. 2 is a schematic view of a first embodiment of a computer system according to the present invention, including a first embodiment of software according to the present invention; and

FIG. 3 is a schematic view of a second embodiment of software according to the present invention.

### DETAILED DESCRIPTION

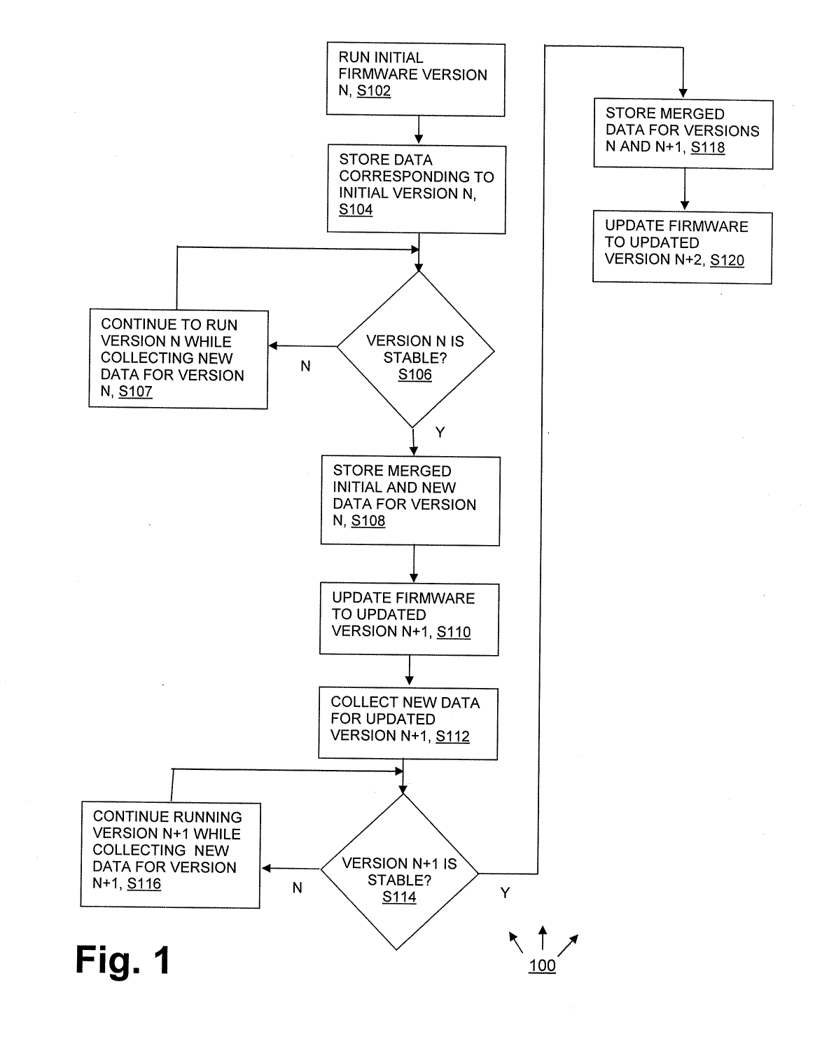

FIG. 1 shows a method 100 according to the present invention in flowchart form. The method embodiment 100 applies to a firmware update. To explain the method in general terms, initial data for firmware version N is used for a period until the version N firmware is deemed stable, collecting and updating error data all the while. (See steps S102, S104, S107 and S106.) When version N is running stably, then a full data set for firmware version N is created, stored and marked “active” based on known firmware issues associated with a known set of hardware at step S108. As system firmware updates to version N+1 (see step S110), the data set N (the first list) is transitioned to data set N+1 (the second list) after a trial period. The trial period may be based on time and/or on discrete events that occur in the computer system. For example, the trial period may be determined by the original hardware monitoring software and the new monitor per error. In this example, the trial period can be though of as a stabilization period. As a more specific example for teaching purposes, the system may monitor fans every second, and after 3 failed readings determine that there is a problem. In this case, the stabilization period would be made to be at least 3 seconds of running. On the other hand, there could be a problem with a PCIe Card that can only detected after the operating system (“OS”) is turned on. In that case the detection period must be extended to some predetermined period of time measured starting at the point in time that the OS turns on. Those of ordinary skill in the art will be able to determine appropriate trial periods, especially by taking into account hysteresis and/or monitoring intervals that the monitoring software/firmware will generally already be using. The trial period should be based on whatever hardware error would take the longest to detect, and should be made at least as long (speaking operationally and/or temporally) as the longest-to-detect errors would take to manifest themselves.

At step S118, data set N+1 (the second list) and data set N (the first list) are compared. Errors on the second list, but not the first list, are determined to be firmware issues and not hardware issues. The errors on the second list may be provided to a user, to a system technician or to specialized diagnostics programs (whether running remotely, locally or in a distributed manner). At step S118, the error reporting instructions combine the old firmware issues yet to be fixed and the new ones induced by the new version of firmware.

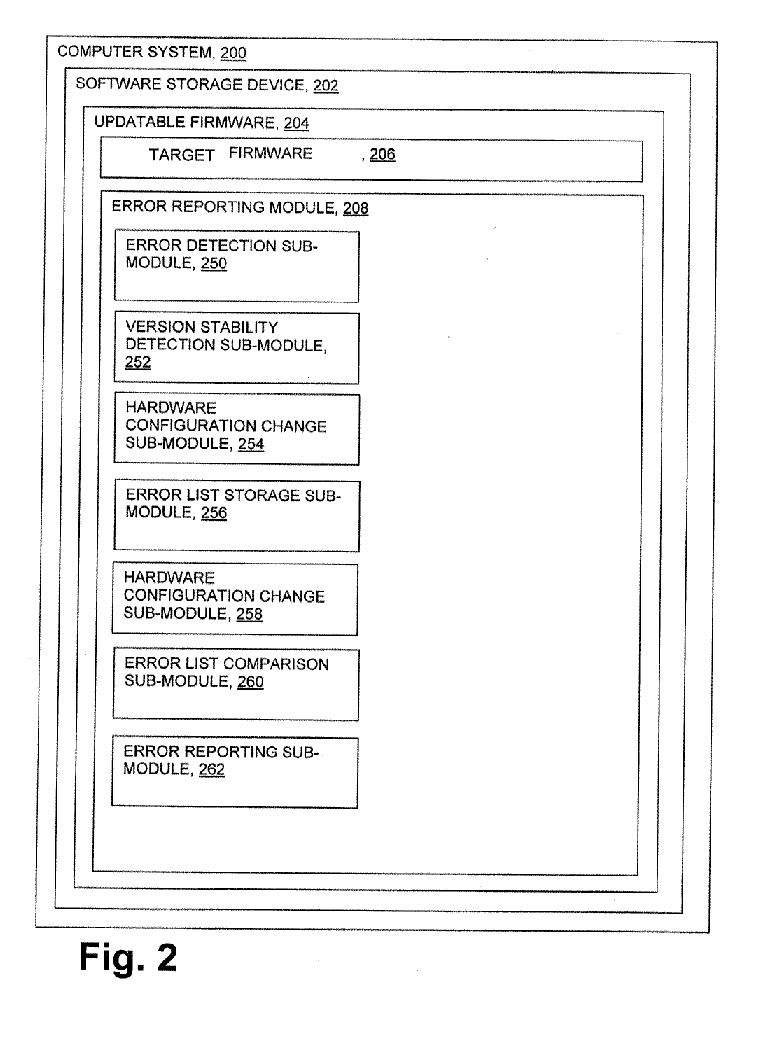

FIG. 2 shows computer system 200 including software storage device 202. Computer system 200 may include only a single computer (in any form now known or to be developed in the future), or it may include multiple computers and/or multiple computer peripheral devices (in any form now known or to be developed in the future). In embodiments where computer system 200 includes multiple hardware components: (i) these may be in close physical proximity to each other and/or dispersed over a large geographic area; and/or (ii) the components may communicate data to each other (as may be needed) according to any methods now known or to be developed in the future.

Software storage device (see DEFINITIONS section) 202 includes the target firmware 206; and error reporting module 208. In this example, the target firmware is the target non-hard-ware for purposes of error reporting, which is to say that it is the non-hard-ware that is subject to update, and to error detections prior to the update(s) and after the update(s). While in this example, the target non-hard-ware takes the form of firmware, it could alternatively be software or a combination of software and firmware. Error reporting module 208 includes: error detection sub-module 250; version stability detection sub-module 252; hardware configuration change sub-module 258; error list comparison sub-module 260; and error reporting sub-module 262.

Error detection sub-module 250 detects errors while a version of the target firmware will be running, in which case firmware is running. Sometimes a previous version of the target firmware will be running, in which case the error detection sub-module is creating or refining a first list of errors associated with the previous version of the target firmware. Sometimes a newly-updated version of the target firmware will be running, in which case the error detection sub-module is creating or refining a second list of errors associated with the current (or updated) version of the target firmware.

Version stability detection sub-module 252 determines when the running version of the target firmware (previous or updated) is running stably such that it is unlikely to generate or correct for any errors on the list being generated in error detection sub-module 250. This is helpful to know so that the error detection sub-module can be stopped when it is not needed and so that an image of the list of errors being detected can be saved in a somewhat permanent manner for future reference. However, this version stability detection may not be needed in all embodiments of the present invention. For example, error detection and associated list storage could be an always-ongoing process.

Hardware configuration change sub-module 258 detects a change in the relevant hardware configuration. This detection could be performed automatically, essentially by pinging the hardware resources on an ongoing basis. This detection could be performed manually (in whole or in part), such that a human user alerts sub-module 258 to the hardware change. In this embodiment, a change in the hardware will simply mean that error lists are not compared, or at least that list(s) generated before the detected hardware change are not compared to list(s) generated after the hardware change.

Error list comparison sub-module 260 compares lists generated by the error detection sub-module. In this embodiment, lists are only compared if there has been a change in version of the target firmware and no change in the hardware configuration, however, these limits on the comparison operation may not be applied in all embodiments of the present invention. In this embodiment, the list for an updated version is only compared only to the list for the version that was previously running immediately before the update that was made, however, this limit on list comparison may not be applied in all embodiments of the present invention. For example, a list for an updated version could be compared to all previous lists that have ever been generated, or compared at least to all previous lists that have been generated subsequent to the latest hardware change. As a further example of a modification in the identity of lists that are compared by the comparison sub-module, consider the case that the target firmware has not had its various versions installed in order. Consider that the target firmware was updated with a first update, but then backwards-updated back to the original version of the target software, and then later updated from the reinstallation of the original version directly to a second update version that is subsequent to the first update which had been temporarily installed, but then removed. In this case, some embodiments of the present invention might be designed to compare the list for the second update to the list for the first update, even though the first update was not the version running immediately before the second update was made.

Error reporting sub-module 262 reports the results of the comparison of the lists in human and/or machine readable format.

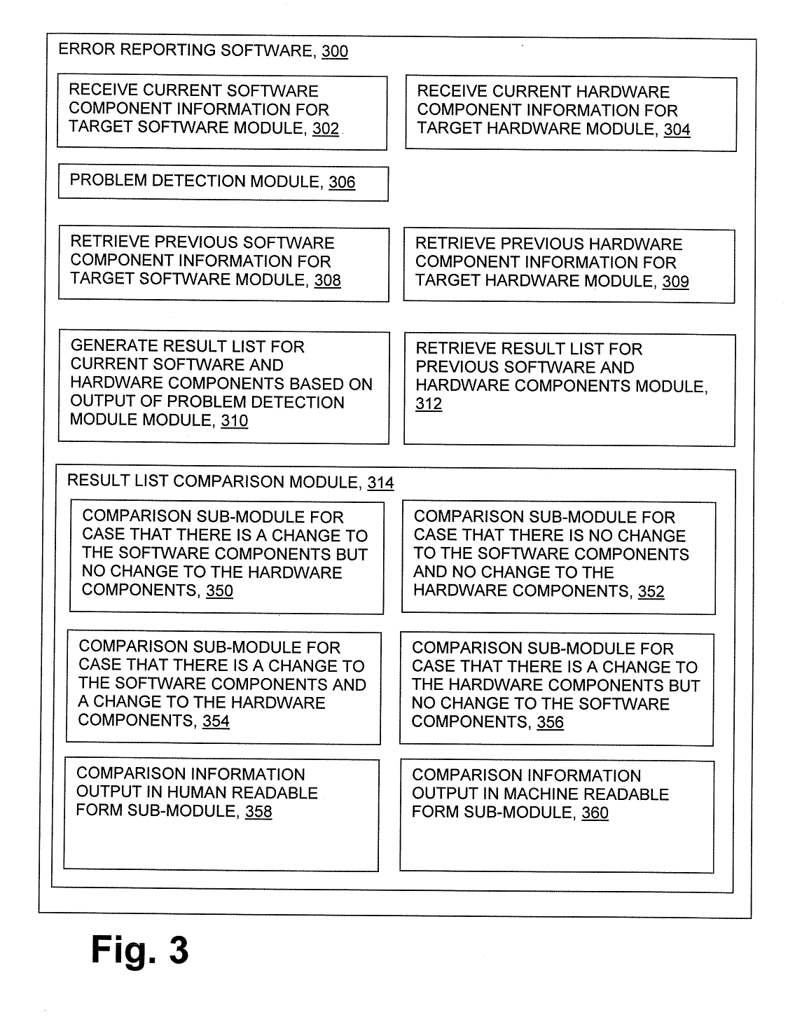

FIG. 3 shows error reporting software 300 including: receive current software component information for target software module 302; receive current hardware component information for target hardware module 304; problem detection module 306; retrieve previous software component information for target software module 308; retrieve previous hardware component information for target hardware module 309; generate result list for current software and hardware components based on output of problem detection module module 310; retrieve result list for previous software and hardware components module 312; and result list comparison module 314. The result list comparison module includes: comparison sub-module for case that there is a change to the software components but no change to the hardware components 350; comparison sub-module for case that there is no change to the software components and no change to the hardware components 352; comparison sub-module for case that there is a change to the software components and a change to the hardware components 354; comparison sub-module for case that there is a change to the hardware components but no change to the software components 356; comparison information output in human readable form sub-module 358; and comparison information output in machine readable form sub-module 360.

At least some embodiments of the present invention do not compare to recommended configurations or use rules, such as those shown in U.S. Pat. No. 7,051,243 (“Helgren”). Rather, in error reporting software 300 comparison is made to the previous configuration, whatever it happens to be. Rules are defined to be an identification of an issue or describing a recommended configuration. Software 300 uses the identification of an issue as an input which can be modified to suggest an error in firmware/software rather than configuration. Software 300 is keying off of only information available at the system with a small history. While some embodiments of the present invention may use rule-based logic and software to supplement the comparison of first and second lists disclosed herein, error reporting software does not rely on a rules engine and does not require logic used to implement and/or update rules. The comparison of first and second lists is a powerful technique, but also a simple one. Error reporting software 300 could be used in conjunction with a known bug list, but, again, this is not required, or even necessarily preferred.

Receive current software component information for target software module 302 receives information identifying the version of the target software. By receiving this information, the error reporting software can determine whether the target software has just been updated. This updating of the software will trigger the new list creation and the list comparison functions of error reporting software 300 which will be discussed in more detail below. It is noted that an update to the target software may not be the only event that triggers list generation or list comparison. Other conditions, such as a predetermined schedule, troubled operation of the target software, a change in hardware configuration, etc. may also trigger list comparison.

Receive current hardware component information for target hardware module 304 receives information identifying the version of the target software. By receiving this information, the error reporting software can determine whether the relevant hardware configuration has been changed. This is potentially important for list comparison purposes. If the hardware has not been changed as between two lists that are being compared, then this can help identify errors as non-hard-ware errors as will be discussed below. A determination of a hardware configuration change may also be used in other ways. For example, it may help the error reporting software determine that a detected error is a hardware error occasioned by a hardware change.

Problem detection module 306 detects errors for whatever version of the target software is currently running. Problem detection software may also determine that tentatively identified errors are not actually errors. In some embodiments problem detection module is a conventional prior art problem detection module, as these kinds of modules currently exist for use in making an active error list (but not for comparison of multiple error lists). Alternatively, problem detection module 306 my be any type of problem detection module to be developed in the future that is effective in detecting problems for the purpose of making error lists. In some embodiments, problem detection module uses only predetermined, pre-existing code to detect its problems. In other embodiments, the problem detection module may reach out for updated problem detection rules or other techniques on an ongoing basis. It can be helpful for the problem detection module to reach outside of the system in cases where knowledge about how to detect problems and how to distinguish real problems from non-problems is being continually and substantially expanded.

Retrieve previous software component information for target software module 308 retrieves the version information for one or more previous versions of the target software that have been run on the target hardware. This information is needed to retrieve lists from previous versions for comparison purposes as will be discussed below.

Retrieve previous hardware component information for target hardware module 309 retrieves configuration information for any previous configurations of the target hardware which may have been in use at previous times. This information is needed to help perform list comparison as will be discussed below.

Generate result list for current software and hardware components based on output of problem detection module module 310 generates an active error list (no separate reference numeral) for the version of the target software currently running on the current target hardware configuration. This result list is based upon the problem detection performed by the problem detection module.

Retrieve result list for previous software and hardware components module 312 retrieves previous result lists (also called error lists or active error lists) for previous versions of the target software and/or for previous hardware configurations. In some embodiments, only lists based upon a hardware configuration identical to the current configuration will be retrieved. In other embodiments, lists for previous hardware configurations will be retrieved. In some embodiments, only the immediately previous list will be stored and retrieved. In other embodiments, multiple lists will be retrieved.

Result list comparison module 314 compares the current result list generated by module 310 to one or more result lists retrieved by module 312.

Comparison sub-module for case that there is a change to the software components but no change to the hardware components 350 compares the current result list and a previous result list in the case that there has been a change in software components (such as an update), but no change to the hardware configuration. If an error on the current result list is also on the previous result list, then this error will be classified as a pre-existing problem not caused by the update. If an error on the current result list does not appear on the previous result list then this error will be classified as a non-hard-ware error caused by the update. This classification as a non-hard-ware error caused by the update is potentially helpful because: (i) it will not cause the user to needlessly replace her hardware; and (ii) there may be remedial actions that can be taken, such as a version roll-back to a previous version of the non-hard-ware.

Comparison sub-module for case that there is no change to the software components and no change to the hardware components 352 compares the current result list and a previous result list in the case that there has been a change in hardware configuration, but no change to the software version as between the two compared lists.

Comparison sub-module for case that there is a change to the software components and a change to the hardware components 354 compares the current result list and a previous result list in the case that there has been a change in software components (such as an update), and also a change to the hardware configuration.

Comparison sub-module for case that there is a change to the hardware components but no change to the software components 356 compares the current result list and a previous result list in the case that there has been a no change in software components, and also no change to the hardware configuration. The results should be identical, and any discrepancy may indicate corruption of the non-hardware and/or damage to a hardware component.

Comparison information output in human readable form sub-module 358 outputs comparison information from the result list comparison(s) in human readable form. Comparison information output in machine readable form sub-module 360 outputs comparison information from the result list comparison(s) in machine readable form.

Now an embodiment of the present invention (no corresponding Figures) will be discussed, which embodiment includes a BIOS/UEFI (“Unified Extensible Firmware Interface”) monitoring a DIMM (“dual in-line memory module”), with a call home application. The system is up and running. The BIOS has collected available inventory information from the running system. The list of errors is stable and there is one warning on hard drive . The related firmware version(s) are recorded. The inventory, list problems and firmware versions are recorded. The user then updates BIOS firmware to a newer version. After the system is powered on and stable, the hardware and firmware inventory are collected. A new list of errors is gathered. In some embodiments, a service processor could also monitor the DIM or the OS could monitor the DIM. It should be noted that if a final list exists, then it can be compared and any new thing(s) identified. Note also that using the embodiment described in this paragraph: (i) may remove systems that use BIOS, and not URFA, from the comparison, and (ii) systems such as IBM POWER servers do not use either BIOS or URFA, but rather use “low level firmware.” Ultimately, error reporting software according to the present invention should be cognizant of whether BIOS, URFA, low level firmware and/or other comparable fundamental computer system modules are being used.

This time the problems list the single hard drive as before and a new failure on the DIMM. Without the list comparison feature of at least some embodiments of the present invention, the system would show a status of the hard drive warning and a fault on the DIMM. The DIMM error would be flagged as new and a service ticket is opened with the manufacturer to replace the failed DIMM or time would be spent to isolate and better understand the problem. However, by using the result list comparison feature of the present invention, the system will identify that the hardware is the same as last boot, and all of the related firmware except the BIOS firmware is updated. The current list of errors is compared to the previous list of one error. The comparison results show there is one new DIMM error. The system then indicates that it is more likely that an error in the firmware is causing the DIMM fault to be reported rather than the DIMM actually failing during the update.

An internal table similar to release notes or firmware change histories has eliminated the cases that new monitoring of DIMMs will report this failure. The system then sends the HW, inventory firmware versions and problem lists to the manufacture where the problem is routed to development and test to validate the firmware bug and correct in the next version. The operator of the server has a choice to go back to the previous version or stay on the version that they are on. The operator chooses to fall back to the previous version and the DIMM error no longer exists. The customer has confidence that the HW is stable and that the problem is not in the currently running system. No parts are replaced.

Development, test and service work together to fix the problem and update the knowledge base, which is where it gets documented. This system does not necessarily use a knowledge base of rules. Rather, it automates the first basic step of problem determination of identifying what changed and using probability decides that what changed is the most likely problem. The error reporting can be changed to report the firmware error instead of the hardware error. The information used is limited to the available inventory that can be seen by the monitor. This can be a huge improvement over reporting a hardware error and talking to the customer only to discover that someone else has updated the firmware. The system may avoid false positives by tracking what new problems are detected by monitoring have been added to each firmware version and excluding those errors from the current list of errors that could be indicated as SW/FW errors instead of HW errors.

The present invention can also be applied at any higher level of the system management stack: on board service processor, operating system, chassis management module, rack manager, or data center monitoring system. The invention may even work better at a higher level of systems management since it can potentially see a larger collection of inventory, firmware versions and software versions.

Now that embodiment(s) have been described with reference to the Figures, some additional comments will be made. Based on only the abstract and solution paragraphs (the rest was in a foreign language). In at least some embodiments of the present invention: (i) the system can monitor/detect faults; (ii) the system can send notifications of faults; and/or (iii) there is a list of current faults kept during operation of the software and/or firmware. In at least some embodiments of the present invention, the system does not merely send a list of additional faults and/or flag a fault of interest, leaving up to the receiver of the list of additional faults to interpret the additional fault details. Rather, in at least some embodiments of the present invention, previous fault details are used to perform a comparison with fault details of updated non-hardware, based on a known/stable hardware configuration. Various embodiments of the present invention may or may not send a list of faults to the end user (or to any human user at all).

In at least some embodiments of the present invention: (i) the system can monitor and/or detect faults; (ii) there is a list of existing or previous faults; and/or (iii) have suppression of an error. In at least some embodiments of the present invention: (i) the error reporting code does not look for similar events in the history with the same root cause when an error is encountered in order to identify the error as a current error or a previous error; and (ii) the error reporting code looks for new errors (correctable and uncorrectable) not in the history and redirects the root cause of the error to the change in firmware versions. As those of skill in the art will appreciate, the list of hardware errors that may be detected and reported by error reporting software is huge—basically anything with a sensor. Some of these potentially detectable hardware errors (such as, faults and/or predicted failures) include (but are not limited to) those related to: CPUs, VPD chips, security chips, hard drives, flash drives, daughter cards, system boards, memory, input/output (“IO”) adapters, special purpose cards, batteries, bio-metric devices, video devices, displays, cameras and so on. As an example of a more specialized application, error reporting software according to the present invention could also be used for monitoring meteorological equipment, with detection of failures after a software upgrade for wind speeds, pressure, due point and temperature sensors. To speak more generally, when a sensor failure is detected, the real problem could be the hardware of the sensor, or it could be the software that receives and communicates data to and/or from the sensor. The error reporting system of the present invention can help more reliably distinguish between these two different types of error.

At least some embodiments of the present invention: (i) do not necessarily use insertion points to detect and/or identify errors (any pre-existing methods of detecting errors, or any methods to be developed in the future, may be used); and/or (ii) can determine that a root cause of an error is a change in the monitoring system (software/firmware) rather than a root cause in the hardware.

In at least some embodiments of the present invention: (i) errors are detected and an attempt is made to isolate the cause of the failure; and/or (ii) it is assumed that software errors are more common than hardware errors. At least some embodiments of the present invention are primarily focused on accurately reporting the root cause as a firmware/software problem for “new errors” after a firmware/software change.

In at least some embodiments of the present invention: (i) a list of stored problems is used; (ii) the error reporting code simply uses a list that is stored, and assumes that storage space is adequate independent of compression; and/or (iii) the error reporting code uses the list of error data to create a new error in the system that monitors errors.

In at least some embodiments of the present invention: (i) there is a system to monitor hardware and software; (ii) a list of firmware/software versions is maintained; (iii) the error reporting code changes detected hardware errors by new firmware/software and changes the errors reported to be root caused by the new firmware/software.

In at least some embodiments of the present invention: (i) the error reporting code looks at lists to improve monitoring; (ii) does not rely on similarity of an error previously corrected to a new error in order to identify and/or classify an newly-encountered error; (iii) only require a simple list of problems rather than an error log (which error logs may include non problems such as cables being unplugged or users accessing the system); and/or (iv) the error reporting code reports software/firmware errors instead of hardware errors without using historical problem solutions or historical actions other than fault lists. An error log is a historical recording of events that is compiled over normal operating time. While some embodiments of the present invention may use error logs for some purposes, the “fault lists” that are compiled by at least some embodiments of the present invention, are compiled over a relatively short period of time (such, as the trial period, discussed above).

In some embodiments of the present invention: (i) the error reporting code reports software/firmware errors instead of hardware errors without using historical hardware errors; (ii) the lists of errors and the information yielded by comparing error lists is applicable to all hardware components in a computer system (for example, not limited to memory)

In at least some embodiments of the present invention: (i) the computer system that executes the subject software and/or firmware includes in-band system such as an operating system, (ii) the computer system that executes the subject software and/or firmware includes an out of band system such as an embedded service processor; (iii) the computer system that executes the subject software and/or firmware includes a remote system such as IBM Director or Tivoli and/or (iv) the computer system that executes the subject software and/or firmware includes a back office system.

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a non-transient manner in one or more tangible storage medium(s); “software storage device” does not include any device that stores computer code only as a signal.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

1. A detection method controlled at least in part by error reporting software stored on a software storage device, the method comprising the steps of:
(i) providing a target non-hard-ware component having version N;
(ii) subsequent to step (i), running the version N target non-hard-ware on a set of target hardware and simultaneously detecting a first result list of active problems;
(iii) during and/or subsequent to step (ii), saving the first result list;
(iv) subsequent to step (ii), updating the non-hard-ware to a version N+1;
(v) subsequent to step (iv), running the version N+1 target non-hard-ware on the set of target hardware and simultaneously detecting a second result list of active problems;
(vi) during and/or subsequent to step (v), comparing the first result list and the second result list to obtain comparison-based information; and
(vii) during and/or subsequent to step (vi), outputting the comparison-based information.

2. The method of claim 1 further comprising the steps of:
(viii) prior to step (vi), determining that the hardware configuration of set of target hardware used during step (ii) is the same as the hardware configuration of set of target hardware used during step (v);
(ix) during step (vi), determining that a first error on the second result list is not present on the first result list; and
(x) subsequent to step (ix), classifying the first error as a probable non-hard-ware based error and including this classification in the comparison-based information.

3. The method of claim 2, further comprising the step of:
(xi) subsequent to step (vi), publishing problem(s) in the second result list, but not in the first result list, with respective workaround(s).

4. The method of claim 2, further comprising the step of:
(xi) subsequent to step (vi), generating a defect list for the next fix cycle.

5. The method of claim 2, further comprising the step of:
(xi) subsequent to step (vi), merging the first result list and the second result list to form a merged result list.

6. The method of claim 1 wherein the outputting of step (vii) includes presenting the comparison-based information in a human readable form.

7. The method of claim 1 wherein the outputting of step (vii) includes communicating the comparison-based information in a machine readable form.

8. The method of claim 1 further comprising the steps of:
(viii) prior to completing step (ii), determining that the version N target non-hard-ware has been stabilized; and
(ix) prior to completing step (v), determining that the version N+1 target non-hardware has been stabilized.

9. The method of claim 1 wherein the target non-hard-ware is firmware.

10. The method of claim 1 wherein the target non-hard-ware is software.

11. Error reporting software stored on a software storage device, the error reporting software being designed to report errors in at least versions N and N+1 of a target non-hard-ware as running on a set of target hardware, the software comprising:
an error detection module programmed to generate: (i) a first result list of errors encountered when version N of the target software is running on the set of target hardware and (ii) a second result list of errors encountered when version N+1 of the target software is running on the set of target hardware;
an error list comparison module programmed to compare the first result list with the second result list to obtain comparison-based information; and
an error reporting module programmed to output the comparison-based information.

12. The software of claim 11 further comprising a hardware configuration change module programmed to determine whether the set of target hardware is changed in configuration between the generation of the first result list and the second result list, wherein the error list comparison module is further programmed to:
classify a first error as a probable non-hard-ware based error when the first error is on the second result list but not the first result list, and
include this classification in the comparison-based information.

13. The software of claim 12 wherein the error reporting module is further programmed to publish problem(s) in the second result list, but not in the first result list, with respective workaround(s).

14. The software of claim 12 wherein the error list comparison module is further programmed to generate a defect list for the next fix cycle.

15. The software of claim 12 wherein the error list comparison module is further programmed to merge the first result list and the second result list to form a merged result list.

16. A computer system comprising:
a processing hardware set;
a software storage device; and error reporting software;
wherein:
the processing hardware set is structured, located, connected and/or programmed to run the error reporting software;
the software storage device is structured, located, connected and/or programmed to store the error reporting software; and
the error reporting software is designed to report errors in at least versions N and N+1 of a target non-hard-ware as running on a set of target hardware; and
the error reporting software comprises:
an error detection module programmed to generate: (i) a first result list of errors encountered when version N of the target software is running on the set of target hardware and (ii) a second result list of errors encountered when version N+1 of the target software is running on the set of target hardware,
an error list comparison module programmed to compare the first result list with the second result list to obtain comparison-based information, and
an error reporting module programmed to output the comparison-based information.

17. The system of claim 16 wherein the computer system further comprises an in-band system.

18. The system of claim 16 wherein the computer system further comprises an out of band system

19. The system of claim 16 wherein the computer system further comprises a remote system

20. The system of claim 16 wherein the computer system further comprises a back office system.
